(19) United States
(12) Patent Application Publication
(10) Pub. No.: US 2013/0105250 A1
(43) Pub. Date: May 2, 2013

(54) SPEED LIMITER FOR AN ELEVATOR

(71) Applicant: INVENTIO AG, Hergiswil NW (CH)

(72) Inventors: Daniel Meierhans, Luzern (CH); Miriam Heini, Eschenbach (CH); Reto Drayer, Affoltern am Albis (CH); Faruk Osmanbasic, Cham (CH)

(73) Assignee: INVENTIO AG, Hergiswil NW (CH)

(21) Appl. No.: 13/661,584

(22) Filed: Oct. 26, 2012

(30) Foreign Application Priority Data
Oct. 27, 2011 (EP) 11186928.5

(51) Int. Cl. B66B 5/00

(52) U.S. Cl. 187/350

(57) ABSTRACT

In this speed limiter with cam wheel and pivot lever and pivot roller, a force limiter wheel with a plurality of dogs is provided at the pivot lever instead of a dog entering into the path of ratchet wheel teeth, wherein the force limiter wheel is braked by means of a slip clutch. If in the case of triggering the braking force in the limiter cable exceeds the force of the slip clutch the force limiter wheel rotates at the dog disposed in engagement with the ratchet wheel teeth, in which case the cable pulley rotates therewith and the stress in the limiter cable builds up and the succeeding dog enters into the path of the ratchet wheel teeth and blocks the cable pulley again. The parts participating in the triggering can thereby be protected from excessive action of force.

### CROSS-REFERENCE TO RELATED APPLICATION

This application claims priority to European Patent Application No. 11186928.5, filed Oct. 27, 2011, which is incorporated herein by reference.

### FIELD

The disclosure relates to a speed limiter for an elevator.

### BACKGROUND

A speed limiter which monitors the travel speed of an elevator cage has become known from the specification DE 36 15270 A1. A cable pulley with a cable groove is rotatably mounted on a housing by means of a first axle. The cable groove receives a limiter cable reproducing the speed of the elevator cage, wherein the ends of the limiter cable are connected with a safety brake arranged at the elevator cage. A cam wheel with cams is fixedly connected with the cable pulley. A ratchet wheel is also provided at the cam wheel. A double-armed pivot lever is pivotably mounted on a second axle connected with the housing. Arranged at a first arm of the pivot lever is a rotatable pivot roller which rolls on the edge surface of the cam wheel.

The pivot roller is pressed onto the edge surface, which serves as roller path, by means of a restraining spring connected with the housing. The end of a second arm of the pivot lever is constructed as a pivot dog which enters into the path of the ratchet wheel teeth when the pivot roller rolls over a cam. The pivot dog is lifted out of the path of the ratchet wheel teeth when the pivot roller rolls between two cams or into a cam valley. If the speed of the elevator cage exceeds a predetermined value the pivot dog remains entered into the path of the ratchet wheel teeth and blocks the cable pulley.

In at least some situations, in the case of triggering uncontrollable forces can arise at the parts of the speed limiter, at the limiter cable and at the safety brake of the elevator cage.

### SUMMARY

At least some embodiments include a speed limiter which in the case of triggering reliably actuates the safety brake of the elevator cage and nevertheless protects the parts, inclusive of the speed limiter, participating in the triggering from excessive action of force.

In at least some embodiments, the restraining force, which is necessary for triggering the safety brake of the elevator cage, in the limiter cable is definable.

Instances of damage or peak loads on safety-relevant parts participating in the triggering of the safety brake are excluded. The reliability of the elevator and the safety for users of the elevator can thereby be improved and susceptibility of the parts to disturbance can be reduced.

### BRIEF DESCRIPTION OF THE DRAWINGS

The present disclosure is explained in more detail by way of the accompanying figures, in which:

FIG. 1 shows a schematic illustration of an exemplifying elevator installation with an exemplifying device for monitoring and shutting down an elevator installation,

FIG. 2 shows a speed limiter for monitoring the speed of an elevator cage,

FIG. 3 shows details of a pre-switching-off lever and

FIG. 4 shows details of a force limiter wheel.

### DETAILED DESCRIPTION

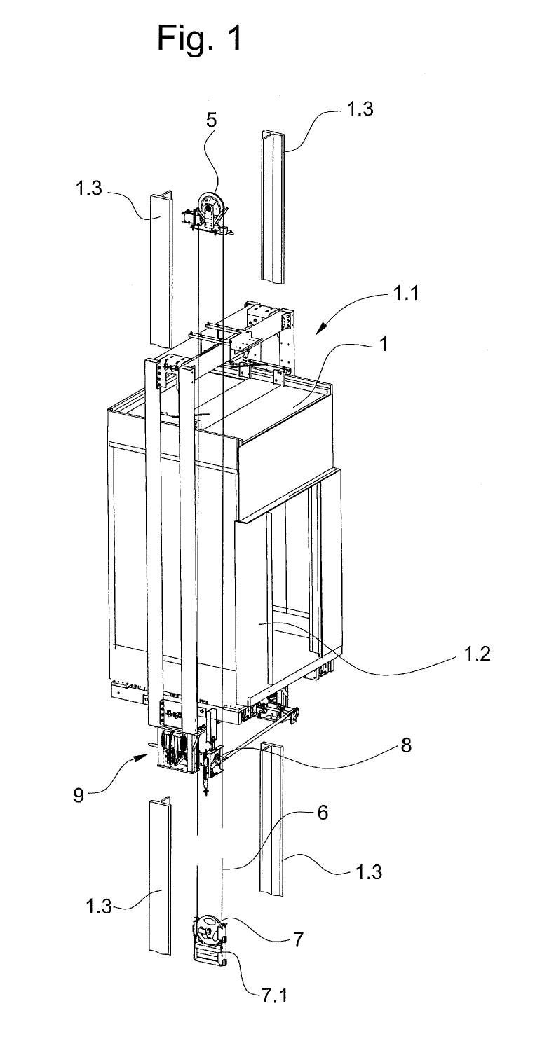

An elevator cage which is movable in an elevator shaft 1.1 and which is connected with a counterweight by means of a support cable guided over a drive pulley is denoted by 1 in FIG. 1. Drive pulley, support cable and counterweight are not illustrated. A cage door 1.2 closes off the elevator cage 1. Guide rails 1.3 guide the elevator cage 1 on its path. Provided for monitoring the speed of the elevator cage 1 or of the counterweight is a speed limiter 5 operating on the pivot lever principle, wherein the movement of the elevator cage 1 or of the counterweight is transmitted by means of a limiter cable 6 to the speed limiter 5. The limiter cable 6 extends over the entire shaft height and is deflected at the lower shaft end by means of a deflecting roller 7 and tensioned by means of a tensioning weight 7.1 as well as guided at the upper shaft end over a cable pulley of the speed limiter 5. The ends of the limiter cable 6 are fixed to a trigger mechanism 8 which is arranged at the elevator cage 1 and which in the case of an emergency or in the case of triggering actuates a safety brake 9 arranged at the elevator cage 1.

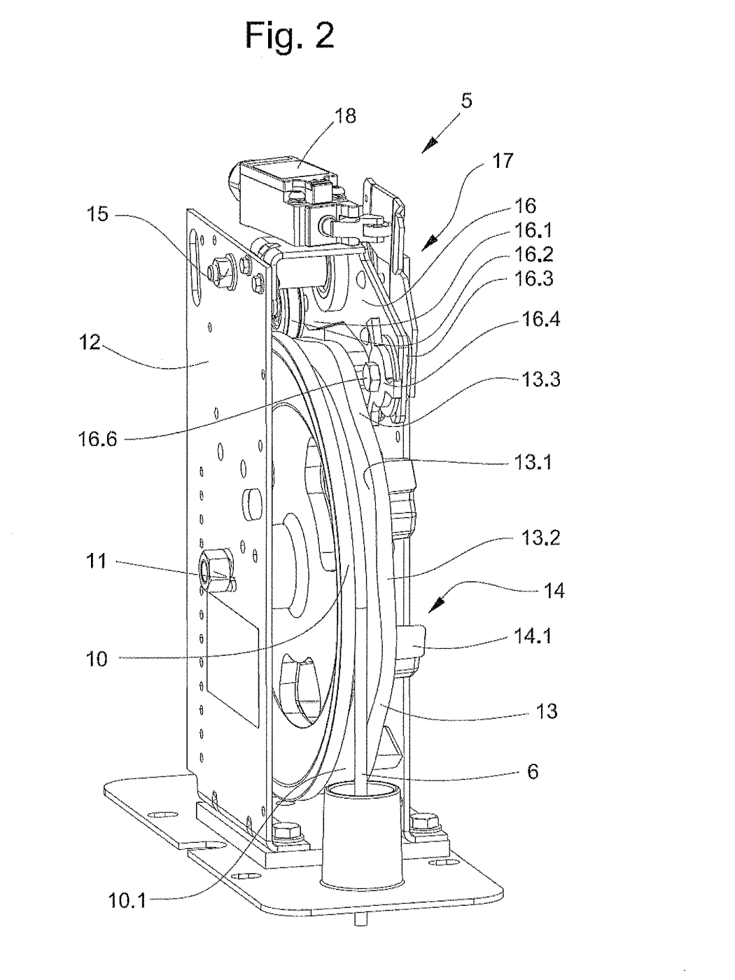

FIG. 2 shows the speed limiter 5 which monitors the travel speed of the elevator cage 1. The cable pulley 10 with a cable groove 10.1 is rotatably mounted on a housing 12 by means of a first axle 11. The cable groove 10.1 receives the limiter cable 6 reflecting the speed of the elevator cage 1, wherein the ends of the limiter cable 6 are connected with the safety brake 9 arranged at the elevator cage 1. A cam wheel 13 with cams 13.1 is fixedly connected with the cable pulley 10. A ratchet wheel 14 is also provided at the cam wheel 13. A double-armed pivot lever 16 is pivotably mounted on a second axle 15 connected with the housing 12. A rotatable pivot roller 16.2 which rolls on an edge surface 13.2 of the cam wheel is arranged at a first arm 16.1 of the pivot lever 16. The pivot roller 16.2 is pressed onto the edge surface 13.2, which serves as roller path, by means of restraining spring connected with the housing 12. Arranged at the end of a second arm 16.3 of the pivot lever 16 is a force limiter wheel 16.4 which enters into the path of the ratchet wheel teeth 14.1 when the pivot roller 16.2 rolls over a cam 13.1. The force limiter wheel 16.4 is lifted out of the path of the ratchet wheel teeth 14.1 when the pivot roller 16.2 rolls between two cams or into a cam valley 13.3. If the speed of the elevator cage 1 exceeds a predetermined value the force limiter 16.4 remains entered into the path of the ratchet wheel teeth 14.1 and blocks the cable pulley 10.

A double-armed pre-switching-off lever 17 actuable by means of the ratchet wheel 14 is pivotably arranged at the second arm 16.3 of the pivot lever 16, wherein the pre-switching-off lever 17 switches off the elevator drive by means of a switch 18 and engages the drive brake.

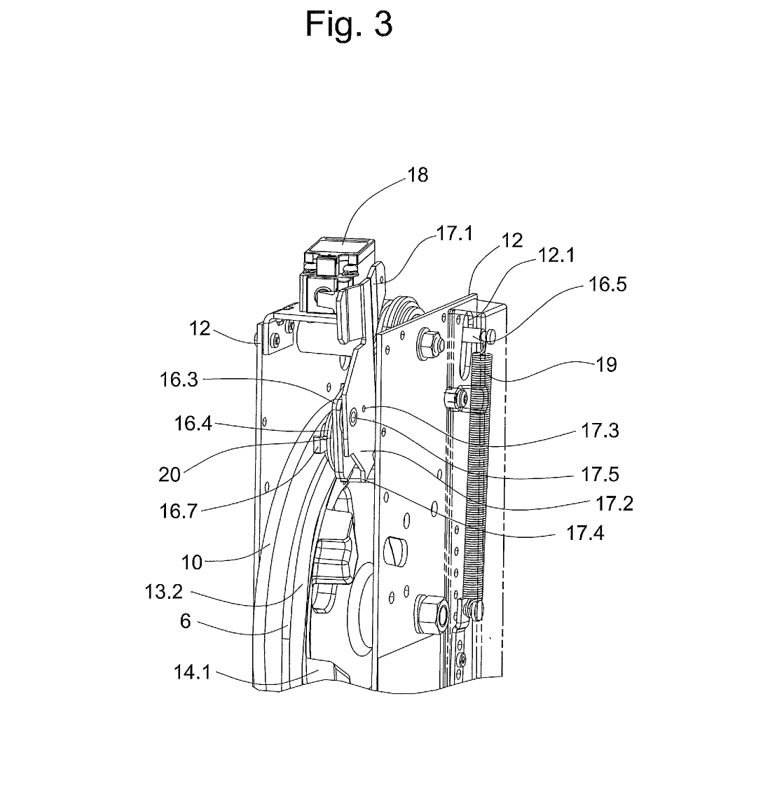

FIG. 3 shows details of the pre-switching-off lever 17, which comprises a third arm 17.1 and a fourth arm 17.2 and is pivotably mounted on a third axle 17.3 at the second arm 16.3 of the pivot lever 16. In the case of a triggering a first dog 17.4 arranged at the fourth arm 17.2 enters into the path of the ratchet wheel teeth 14.1 somewhat earlier than the force limiter wheel 16.4 and is in that case pivoted about the third axle 17.3, in which case the third arm 17.1 actuates the switch 18. In normal operation the pre-switching-off lever 17 is held in a stable position by means of a restraining element 17.5 relative to the second arm 16.3 of the pivot lever 16. A spring-loaded ball can, for example, be provided as restraining element 17.5, which ball partly enters into a bore at the fourth arm 17.2 and in the case of triggering is pushed back by the fourth arm 17.2 against the spring force.

FIG. 3 also shows the above-mentioned restraining spring 19, which is connected at one end with the housing 12 and at the other end with a pin 16.5 of the first arm 16.1 of the pivot lever 16. One end of the restraining spring 19 is connected with the housing 12 at one hole of a row of holes, wherein the hole is selected in correspondence with the rated speed of the elevator cage. Provided at the housing 12 is a slot 12.1 in which the pin 16.5 can freely move. The restraining spring 19 is set so that the pivot roller 16.2 can follow the edge surface 13.2 of the cam wheel 13 insofar as the elevator cage does not exceed its rated speed. If the elevator cage exceeds a defined trigger value preset by the restraining spring 19 then the pivot roller 16.2 elevators off the edge surface 13.2 of the cam wheel 13. The inertia of the pivot lever 16 is greater than the restraining moment of the restraining spring 19. The first dog 17.4 of the four arm 17.2 of the pre-switching-off lever 17 remains in the path of the ratchet wheel teeth 14.1, which leads to pivotation of the pre-switching-off lever 17 without blocking the cam wheel 13. If the speed of the elevator cage rises further, the force limiter wheel 16.4 enters into the path of the ratchet wheel teeth 14.1 and blocks the cable pulley 10.

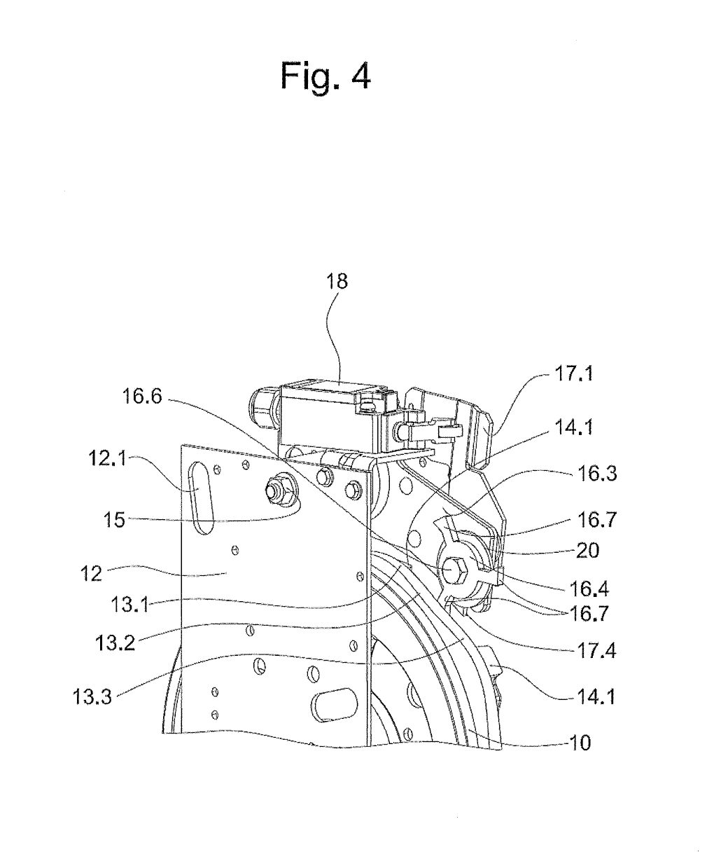

FIG. 4 shows details of the force limiter wheel 16.4, which is rotatably arranged at the second arm 16.3 of the pivot lever 16 by means of a fourth axle 16.6 and is braked by means of slip clutch 20. The braking force can be set, for example, by means of plate springs arranged between force limiter wheel 16.4 and second arm 16.3. Alternatively, spring-loaded balls which partly enter into bores of the force limiter wheel 16.4 can also be provided.

Three second dogs 16.7 are, for example, provided at the force limiter wheel 16.4, wherein a second dog 16.7 enters into the path of the ratchet wheel teeth 14.1 if the spring roller 16.2 rolls over a cam 13.1. If in the case of triggering the braking force in the limiter cable exceeds the force of the slip clutch 20 the force limiter wheel 16.4 rotates at the second dog 16.7 disposed in engagement with the ratchet wheel tooth 14.1, in which case the cable pulley 10 co-rotates and the stress in the limiter cable 6 builds up and the succeeding second dog 16.7 enters into the path of the ratchet wheel teeth 14.1 and blocks the cable pulley 10 again.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. We therefore claim as our invention all that comes within the scope and spirit of these claims.

We claim:

1. An elevator speed limiter, comprising:
a cable pulley, the cable pulley being drivable by a limiter cable;
a cam wheel connected with the cable pulley;
a ratchet wheel, the ratchet wheel comprising ratchet teeth and being arranged at the cam wheel;
a pivot lever, the pivot lever comprising a first arm and a second arm;
a pivot roller rolling on the cam wheel and provided at the first arm; and
a force limiter wheel comprising a plurality of dogs, the force limiter wheel being provided at the second arm, each dog of the plurality of dogs being configured to enter a path of the ratchet teeth.

2. The elevator speed limiter of claim 1, further comprising a slip clutch that brakes the force limiter wheel, the slip clutch being provided between the pivot lever and the force limiter wheel, wherein when a force of the limiter cable acts on the cable pulley the force limiter wheel is rotated and an adjacent one of the plurality of dogs enters the path of the ratchet teeth.

3. The elevator speed limiter of claim 2, the slip clutch comprising plate springs that brake the force limiter wheel up to the force of the limiter cable.

4. The elevator speed limiter of claim 2, the slip clutch comprising spring-loaded balls that partly enter bores of the force limiter wheel and that brake the force limiter wheel up to the force of the limiter cable.

5. An elevator, comprising:
an elevator cage movable in an elevator shaft;
a safety brake coupled to the elevator cage; and
a speed limiter for monitoring elevator cage speed, the speed limiter comprising,
a cable pulley, the cable pulley being drivable by a limiter cable, the limiter cable transmitting the elevator cage speed to the speed limiter, ends of the limiter cable being fixed to the safety brake,
a cam wheel connected with the cable pulley,
a ratchet wheel, the ratchet wheel comprising ratchet teeth and being arranged at the cam wheel,
a pivot lever, the pivot lever comprising a first arm and a second arm,
a pivot roller rolling on the cam wheel and provided at the first arm, and
a force limiter wheel comprising a plurality of dogs, the force limiter wheel being provided at the second arm, each dog of the plurality of dogs being configured to enter a path of the ratchet teeth.
